(19) United States
(12) Patent Application Publication
(10) Pub. No.: US 2012/0247566 A1
(43) Pub. Date: Oct. 4, 2012

(54) TUBULAR PIPE FOR TRANSPORTING LIQUID SODIUM

(75) Inventors: Mehdi Moussavi, Paris (FR); Annalisa Ambroso, Paris (FR)

(73) Assignee: AREVA, Paris (FR)

(21) Appl. No.: 13/512,393

(22) PCT Filed: Nov. 30, 2010
(86) PCT No.: PCT/FR2010/052570

§ 371 Date: Jun. 13, 2012

(30) Foreign Application Priority Data
Nov. 30, 2009 (FR) 09 58515

(51) Int. Cl. F17D 1/00; F16L 9/14

(52) U.S. Cl. 137/1; 138/145

(57) ABSTRACT

A tubular pipe (10) for transporting liquid sodium is suitable for inhibiting any leaks of sodium outside the pipe. The pipe includes a pipe body (20) covered on the inside with an inner layer which includes: a first continuous layer (40) made of ceramic or a metal or metal alloy, for being placed in contact with the liquid sodium carried by the tubular pipe; and between the pipe body and the first ceramic layer, an intermediate layer (50) made of a reactive material which, when the layer contacts the liquid sodium, the layer turns into a modified material which has separate electric conductivity from that of the reactive material.

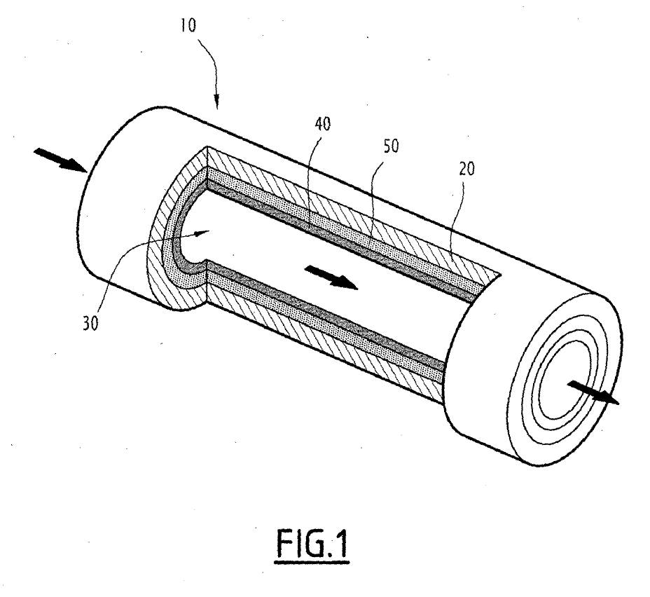

The present invention relates to the field of liquid sodium transport in tubular pipes. It more specifically concerns the detection of the onset of fissures in such pipes, with a view to detecting risks of sodium leaks externally outside the pipes and inhibiting such leaks.

Liquid sodium, namely metal sodium brought to above its melting point (97.8° C.), is a particularly efficient heat transfer and cooling fluid whose thermal conductivity is higher than that of water by a factor 100. This heat transfer fluid is used for the transfer of heat in various types of devices using heat exchange, in particular in some specific engines or cooling devices.

Liquid sodium finds application of particular interest in the nuclear industry field. In addition to its excellent heat transfer properties, which allow the extraction of high volume power, liquid sodium has the specificity of being transparent to neutrons. In other words, liquid sodium is a neutron non-moderator unlike other heat exchange fluids such as water. Sodium in the liquid state, on this account forms, a heat transfer fluid of choice in the primary circuit of fast breeder reactors (FBR), in particular when in particularly pure form (refined sodium known as <<of nuclear quality>> in particular). Sodium additionally has the advantage of displaying behaviour of interest with regard to nuclear radiation, in particular since the activation products of sodium having a relatively short half-life.

As a counterpart to these advantages, liquid sodium nevertheless has the disadvantage of being highly reactive, even more so when brought to high temperature. In particular, having regard to its strong reducing properties, liquid sodium ignites when in contact with oxygen in the air. Also, when it comes into contact with water, sodium generates hydrogen which is likely to lead to explosive reactions. Sodium reactions with water or oxygen also lead to the formation of corrosive products (sodium oxide or hydroxide in particular) which are likely to harm the integrity of the device in which the liquid sodium is used (in particular steel parts).

On this account, for devices using a circulation of liquid sodium, it is essential to detect any incipient sodium leak as rapidly as possible so as to plug this leak at the earliest possible opportunity and avoid massive leaks of liquid sodium. Ideally, it is desirable to be able to detect leak risks further upstream so as preventively to inhibit any onset thereof.

This issue is all the more sensitive in nuclear reactors of fast breeder type in which sodium in the liquid state is brought to very high temperatures (typically 500 to 600° C.), and in which the primary circuit is generally placed in contact with a secondary circuit where the heat transfer fluid is water. Leaks of liquid sodium in such reactors may have dramatic consequences, as illustrated for example by the fire at the Monju plant in Japan in 1995.

With a view to controlling risks related to the use of sodium, different types of devices for detecting sodium leaks have been developed, which use systems for detecting sodium or sodium reaction products with oxygen or water (H2 or NaO in particular) on the direct periphery of the pipe in which the liquid sodium is conveyed.

In this respect, the use has been particularly described of pipes for conveying liquid sodium which are cladded with an outer pipe having a space between the pipe conveying the sodium and the outer pipe provided with detectors of sodium or of sodium reaction products. More generally, it has been proposed to use sensors on the outer periphery of the pipes conveying liquid sodium for the detection, at the time of a leak, of sodium or of its reaction products with water and/or oxygen. Sensors of this type are particularly described in JP 57200846 and JP 57200847.

A sensor of more specific type was described in patent U.S. Pat. No. 4,112,417, which is in the form of a cable attached to the outer wall of a pipe conveying liquid sodium. This detector in the form of a cable comprises a central metal core coated with a first insulating layer in a metal oxide (typically magnesium, beryllium or aluminium oxide) which itself is coated with a thin outer metal layer in a metal corrodible by sodium reaction products of sodium oxide or hydroxide type (for example a layer of copper or austenitic steel or black steel). When in operation, a difference in potential is applied between the metal core and the outer metal layer and the leak current is measured. If sodium is leaking outside the pipe, the sodium reaction products with oxygen and atmospheric water are formed and attack the outer layer of the cable, partially exposing the metal oxide of the central core of the sensor, which in turn reacts with the sodium reaction products with oxygen and atmospheric water, leading to a substantial reduction in the electric resistance of the oxide thereby modifying leakage current and allowing detection.

To allow detection of sodium leaks as rapidly as possible after their onset, increasingly more sensitive detectors have been developed so as to be able to detect leak-related products in increasingly smaller quantities, and hence to identify their presence right at the start of a leak. However the use of detectors of this type, however sensitive they may be, does not prove to be fully satisfactory. With these detectors, sodium leaks are only detectable once they have happened and detection does not allow inhibition of the leak before its onset.

It is one objective of the present invention to provide means for conveying liquid sodium in a tubular pipe avoiding sodium leaks outside the pipe, and which inter alia allows the detection of indicator signs of risks of sodium leaks before such leaks occur, which gives time for preventive action to be carried out on the pipe.

For this purpose the present invention provides a new type of tubular pipe for transporting liquid sodium which, on its inner surface, is provided with a specific coating which allows the detection of any fissure initiation which may, should it develop, lead to a leak of sodium outside the pipe.

More specifically, the subject of the invention is a tubular pie for transporting liquid sodium comprising a pipe body innerly coated with an inner layer characterized in that the structure of the said inner layer is at least a bi-layer structure comprising:
a first continuous layer, in ceramic or metal or metal alloy, intended to be placed in contact with the liquid sodium transported by the tubular pipe; and
between the pipe body and said first layer, an intermediate layer in a reactive material which is modified when in contact with liquid sodium, so that it converts to a modified material having electric conductivity different to that of the reactive material.

The specific structure of the tubular pipe according to the present invention allows the transporting of sodium inside this pipe whilst being capable of preventing any leak of sodium outside the pipe.

With a tubular pipe according to the invention, any process able to lead in fine to a sodium leak outside the pipe involves more or less marked destruction of the continuity of the ceramic layer in contact with the molten sodium. Having regard to the structure of the inner layer present inside the pipe of the invention, the slightest fissuring of the ceramic layer leads to the contacting of the liquid sodium with the reactive material present in the intermediate layer initially isolated from the liquid sodium by the ceramic layer. This contacting of the sodium with the intermediate layer induces the conversion of at least part of the reactive material to a modified material, which modifies the global conductivity of the tubular pipe.

Measurement of the conductivity of the pipe (directly or via parameters related to this conductivity) over time then allows the detection of any phenomenon likely to lead over the longer term to a sodium leak, before such leak occurs, which allows preventive action on the pipe to avoid any risk of sodium leak, this forming a notable advantage compared with currently known techniques for detecting actual sodium leaks.

In this respect according to one particular aspect, the subject of the present invention is a method for transporting liquid sodium allowing the inhibition of risks of sodium leaks, which uses a tubular pipe provided with an inner layer of bi-layer structure such as defined above, and in which:
measurement of the conductivity of the tubular pipe is conducted during the time in which sodium is transported inside the pipe; and
when a variation in conductivity is detected, preventive maintenance on the pipe is carried out, so as to eliminate any risk of leakage related to the phenomenon detected by the variation conductivity.

The measurement of conductivity performed according to this method can entail measurement of the global conductivity of the tubular pipe over its entire length. For this purpose, as a general rule, the outer wall of the tubular pipe is provided with two electrodes, a voltage is applied to the terminals of these two electrodes and the current circulating between these two points is measured. Said means for measuring conductibility allow the detection of a variation in the global conductibility of the wall, identified when the measured current varies. This technique is simple to implement but nevertheless has the disadvantage of not providing any indication on the exact location of the fissure. In addition, it requires direct contact between the electrodes and the pipe. The detection of a variation in conductivity measured in this manner solely reflects that there is at least one portion of the pipe where a phenomenon has occurred likely to lead to a sodium leak. The preventive maintenance to be carried out in this case will concern the entirety of the pipe.

According to one more advantageous embodiment, the measurement of the conductivity of the walls of the tubular pipe is carried out in localized manner whereby the portions in which a phenomenon has occurred likely to lead to a sodium leak are identified more precisely, which then allows preventive maintenance operations to be restricted to these localized portions. To carry out localized measurement of the conductivity of the walls of the tubular pipe, one or more of the following means can in particular be used:
measurement of the conductivity of the tubular pipe in sections and not globally, whereby the preventive maintenance operations are limited to the sections where a modification has been measured. In this case, the measurement of the conductivity per section is typically performed by providing the tubular pipe with several electrodes to obtain several measurement points. These different measurement points can be provided on one same tubular pipe in a single piece, or at points likely to be weakened in particular either side of bends, cross-overs or joins. Measurement of the conductivity per section is typically obtained by surrounding the section of the tubular structure with a device formed of two current loops inducing a uniform magnetic field whose field lines are typically aligned with the axis of the tubular pipe. A change in the conductivity of the tubular pipe associated with the onset of a fissure creates a perturbation of the magnetic waves which can be detected using this type of device. For this purpose, a detector (or collar of detectors) ensuring detection of perturbation of the magnetic field can be arranged for example around the tubular structure in particular at one section thereof to measure the magnetic field integral solely on one angular sector of the section or over the entirety of the section. Any variation in the response of one of the detectors thus located around the tubular structure allows the identification of a variation in conductivity of the medium in the portion covered by the detector, thereby allowing the localized identification of the onset of a fissure. Typically, several detectors can be aligned over the length of the tubular pipe so as to allow efficient detection of magnetic field perturbations at different levels of the said pipe.
measurement of local conductivity by electromagnetic measurement in the low frequency region (typically lower than 10 kHz) which allows the locating of fissures in the progress of being formed by causing a current to circulate in the walls of the pipe and detecting any anomalies of the magnetic field by means of a magnetic sensor, using a method known per se, for example using the CRABE method described in <<Détection de fissure sur structure en mer en présence de salissure marine>> (Fissure detection on structure at sea in the presence of marine fouling)—CRABE Project Ifremer; Actes de Colloques, Colloque ISM 90, No. 12-1991.

To obtain the above-mentioned effects, the reactive material used in the intermediate layer of the pipes according to the present invention may vary to a fairly large extent. In this respect, the intermediate layer present in the inner layer of a tubular pipe according to the invention may comprise a single type of reactive material or, according to another embodiment, a mixture of several separate reactive materials.

Typically, the reactive material present in the intermediate layer comprises at least one compound which reacts with liquid sodium to form a modified material (generally solid) having electric conductivity different to that of the solid compound before reaction with the liquid sodium.

According to one embodiment, compatible with the preceding embodiment, the reactive material present in the intermediate layer may also comprise a mixture of several compounds, advantageously solid, which react together when placed in the presence of liquid sodium to form a modified material having electric conductivity different to that of the initial mixture of compounds.

According to one mode of interest, the reactive material present in the intermediate layer comprises a conductive ceramic of Lisicon type or a mixture of compounds capable of forming a conductive ceramic of Lisicon type when placed in contact with liquid sodium. Advantageously the intermediate layer is fully formed of a Lisicon ceramic or a mixture of compounds capable of forming a ceramic of Nasicon type in contact with liquid sodium.

The so-called Lisicon and Nasicon ceramics (acronyms for <<Lithium Super Ionic Conductor>> and “Natrium Super Ionic Conductor”) are ceramics containing sodium zirconium and zinc containing variable proportions of phosphates and silicates and which typically meet the respective formulas Li₁₊ₓZr₂SiₓP₃₋ₓO₁₂ and Na₁₊ₓZr₂SiₓP₃₋ₓO₁₂, where 0≦x<3. For further details on these ceramics and their preparation, particular reference may be made to the article “Nasicon Solid electrolytes”, in Materials Research Bulletin, vol. 21, no. 3, pp. 357-363 (1986).

According to one variant of interest, the reactive material present in the intermediate layer comprises a ceramic of Lisicon type containing phosphates namely a conductive ceramic meeting the formula Li₁₊ₓZr₂SiₓP₃₋ₓO₁₂ or Na₁₊ₓZr₂SiₓP₃₋ₓO₁₂, where 0≦x<3, x preferably being less than 3, even less than 2. Advantageously, the intermediate layer is formed of said Lisicon ceramic containing phosphates. A ceramic of Lisicon type containing phosphates, in particular of the aforementioned type, has the same conductive properties and is converted to Nasicon of better conductivity, by replacing at least part of the lithium atoms by sodium atoms, typically leading to a Nasicon of formula Na₁₊ₓZr₂SiₓP₃₋ₓO₁₂as per the mechanism described in particular in Materials Science Poland, vol. 454, no. 1 (2006). Whereupon, when a said ceramic of Lisicon type is used as reactive material in a pipe according to the invention, and if a fissure occurs in the ceramic layer in contact with the liquid sodium transported by the pipe, the result is a substantial increase in the conductivity of the walls of the pipe, which can be easily detected.

In addition, it has been found that the reaction of the sodium with a ceramic of Lisicon type containing a phosphate of the aforementioned type, concomitantly leads to another effect of particular interest. The reaction which leads to an increase in the conductivity of the intermediate layer is accompanied by an increase in the volume of this intermediate layer. The effect of this increase in volume is to plug the fissuring of the layer at least provisionally. This local plugging of the fissure delays and even inhibits the formation of a liquid sodium leak to outside the pipe from the formed fissure. Therefore the use of a phosphate-containing Lisicon ceramic in the intermediate layer not only allows detection of phenomena that are potentially the source of a sodium leak, but also allows at least temporary inhibition of the actual onset of a sodium leak providing additional time for ensuring maintenance on the pipe where a leak risk has been detected.

Lisicon ceramics containing phosphates which are particularly well suited to the implementation of this first variant of the invention are particularly ceramics meeting the following formulas: LiZr₂(P0₄)_{3,} Li₃Zr₂Si₂P0_{12.}

The ceramics of formula Li₁₄Zr(GeO₄)₄ prove to be of particular interest.

According to another alternative variant of the invention, the reactive material present in the intermediate layer comprises a mixture of precursor compounds of a ceramic of Nasicon type containing silicates, which forms a said ceramic when in contact with liquid sodium. More specifically, according to this variant, the intermediate layer, in a mixture, comprises zirconium ZrO₂, silica SiO₂, and preferably a phosphate salt in particular an ammonium phosphate e.g. NH₄PO₄.3H₂O.

Preferably, according to this variant, the Si/Zr molar ratio in the mixture is between 1.5 and 3, for example it may be 1.5 and 2.5, this ratio preferably being at least 1.8.

In contact with liquid sodium, the mixture of compounds forms a modified material, namely a conductive ceramic of Nasicon type comprising a silicate, of much higher conductivity than the initial mixture of zirconium salt and silica. Here again, the variation observed allows a distinct detection of fissuring phenomena. According to this variant, the intermediate layer is advantageously entirely formed of a close mixture of precursor compounds of Nasicon ceramic of the aforementioned type.

According to one embodiment, the intermediate layer is entirely formed of a mixture of zirconium ZrO₂, silica SiO₂, and optionally a phosphate salt, to the exclusion of any other compound.

According to another embodiment of interest, the reactive material present in the intermediate layer, in addition to the zirconium ZrO₂, silica SiO₂ and phosphate salt, comprises a lithium carbonate LiHCO₃. In this case, the presence of the phosphate salt is most often required. In this case, the mixture of compounds tends to convert over time, in full or in part, to a ceramic of phosphate Lisicon type. This ceramic of Lisicon type then present in the intermediate layer forms a ceramic of Nasicon type in contact with liquid sodium, according to the mechanism described in the first variant, which again allows the ensured distinct detection of fissuring phenomena.

In addition, irrespective of the embodiment of the second variant, the reaction of the mixture of zinc salt and silica present in the intermediate layer with liquid sodium, as in the preceding variant, is accompanied by a phenomenon of swelling of the intermediate layer which, as in the preceding variant, allows at least a temporary plugging effect of the fissures in the progress of being formed. Therefore here again, in addition to the detection of fissuring phenomena likely to lead over the longer term to a leak of liquid sodium, the use of the reactive material in the intermediate layer allows the delaying even the preventing of the formation of the leak, thereby providing an additional time period for ensuring maintenance on the pipe.

According to preferred embodiments of the invention, the tubular pipe for transporting liquid sodium may advantageously have one or more of the preferred characteristics given below.

In a pipe of the invention, the intermediate layer in a reactive material present in the inner layer is advantageously a continuous layer, preferably of constant thickness, this thickness preferably being at least 50 nm, for example between 100 and 500 nm, and more preferably between 150 and 250 nm.

Typically, the intermediate layer present in the inner layer of the pipes of the invention can be obtained by depositing the material(s) forming the constituent reaction material of the inner layer on the inner surface of the body of the pipe, typically be depositing the reactive material in the form of a film comprising the reactive material (or a precursor thereof) in the solubilized or dispersed state (by impregnation, dipping or spraying for example) followed by drying or heat treatment. The depositing of the intermediate layer can also be carried out by electrolytic deposit or else using techniques of sol-gel type, for example using the techniques described in U.S. Pat. No. 6,911,280

More specifically the inner layers in Lisicon and Nasicon ceramic of the aforementioned type may typically be obtained following the technique described in WO2008/015593.

Also, in a pipe of the invention, the continuous layer in ceramic, metal or metal alloy, intended to be in contact with the liquid sodium transported by the tubular pipe (namely the layer coated with the intermediate layer) preferably has a constant thickness, this thickness advantageously being between 50 and 500 nm, for example between 100 and 300 nm and more preferably between 150 and 250 nm.

This continuous layer, which coats the intermediate layer, may typically be a ceramic layer which can be deposited using any technique known per se. Alternatively it may be a metal or polymetal layer e.g. a layer of single-crystal nickel deposited using the so-called Electrosleeve® technique described for example in the article <<In-situ nuclear steam generator repair using electrodeposited nanocrystalline nickel>> by G. Palumboa, F. Gonzaleza, A. M. Brennenstuhla, U. Erba, b, W. Shmaydaa and P. C. Lichtenbergera

The body of the pipe according to the present invention may be in any material suited for the transport of liquid sodium. Typically, this pipe body may be in stainless steel, zirconium alloy or steel.

The invention is further illustrated with reference to the appended FIGURE which is a schematic, cross-sectional illustration of a tubular pipe according to the invention.

This FIGURE shows a pipe 10 which comprises a pipe body 20 (typically in steel). In the inner space 30 of this pipe body 20, liquid sodium is conveyed.

The pipe body 20 is coated with a continuous inner layer formed of two continuous layers 40 and 50, namely:
a layer 40 in contact with the liquid sodium which is typically a layer of ceramic or else a layer of nickel deposited using the Electrosleeve® technique; and
an intermediate layer 50 located between the pipe body 20 and the ceramic layer 40. This layer comprises (and is typically formed of) a reactive material which, in contact with sodium, is converted to a modified material having different conductivity to the conductivity of the reactive material.

If, during the course of operation, a fissure is initiated in the pipe, one or more fissures are created at the ceramic layer 40 thereby placing the liquid sodium present in the inner space 30 of the pipe in contact with the reactive material of layer 40.

There follows a modification in the conductivity of the wall of the reactor which can easily be detected using the technical means described above (the electrodes or magnetic sensors used for this purpose are not illustrated in the FIGURE).

In addition, if the reactive material of layer 40 is a phosphate-containing Lisicon ceramic or else a mixture of precursor compounds of Nasicon of the aforementioned type, the contacting of the sodium with the layer 40 allows at least provisional plugging of the fissure which may have formed in this layer. This process therefore schematically leads to provisional or durable “self-repair” of the inner layer of the pipe, which allows sufficient mechanical strength of this layer to be maintained for sufficient time to allow preventive maintenance on this pipe, so as to eliminate any risk of leak related to the phenomenon detected by the variation in conductivity.

1. A tubular pipe (10) for transporting liquid sodium, comprising a pipe body (20) coated on the inside with an inner layer, characterized in that the said inner layer has a structure at least of bi-layer structure comprising:
a first continuous layer (40) in ceramic or metal or metal alloy intended to be in contact with the liquid sodium transported by the tubular pipe (10); and
between the pipe body (20) and said first layer (40), an intermediate layer (50) in a reactive material which is modified when it comes into contact with liquid sodium, so that it converts to a modified material having different electric conductivity to the reactive material.

2. The pipe according to claim 1, wherein the reactive material present in the intermediate layer (50) comprises a conductive ceramic meeting the following formula:
Li₁₊ₓZr₂SiₓP₃₋ₓO₁₂
where 0≦x<3.

3. The pipe according to claim 2 wherein the intermediate layer (50) is formed of said conductive ceramic.

4. The pipe according to claim 1 wherein the reactive material present in the intermediate layer (50) comprises, in a mixture, zirconium ZrO₂, silica SiO₂, and preferably a phosphate salt.

5. The pipe according to claim 4 wherein the reactive material present in the intermediate layer (50) comprises a mixture of zirconium ZrO₂, silica SiO₂, a phosphate salt and LiHCO₃.

6. The pipe according to claim 4 wherein the Si/Zr molar ratio in the mixture is between 1.5 and 3.

7. The pipe according to claim 1 6 wherein the intermediate layer (50) in reactive material is a continuous layer having a thickness of at least 50 nm.

8. The pipe according to claim 1 wherein the continuous ceramic layer (40) intended to be in contact with the liquid sodium conveyed by the tubular pipe has a thickness of between 50 and 500 nm.

9. A method for transporting liquid sodium allowing the inhibition of risks of sodium leaks, the said method using a tubular pipe (10) according to claim 1, and wherein:
measurement of the conductivity of the tubular pipe is taken during the time the sodium is conveyed inside the pipe; and
when a variation in conductivity is detected, preventive maintenance on the pipe is carried out so as to eliminate any risk of leak related to the phenomenon detected by the variation in conductivity.

10. The pipe according to claim 5 wherein the Si/Zr molar ratio in the mixture is between 1.5 and 3.
